(19) United States
(12) Patent Application Publication
(10) Pub. No.: US 2026/0274313 A1
(43) Pub. Date: Sep. 17, 2026

(54) Device, System And Method For Obstacle Detection Of A Vehicle

(71) Applicant: Siemens Aktiengesellschaft, München (DE)

(72) Inventors: Marc Zeller, München (DE); Kilian Telschig, Garching (DE)

(73) Assignee: Siemens Aktiengesellschaft, München (DE)

(21) Appl. No.: 19/564,564

(22) Filed: Mar. 12, 2026

(30) Foreign Application Priority Data
Mar. 13, 2025 (DE) 10 2025 109 694.5

(51) Int. Cl. B61L 23/04; B61L 27/04

(52) U.S. Cl. CPC B61L 23/041; B61L 27/04

(57) ABSTRACT

The invention comprises a method for operating AI/ML-based obstacle detection for a vehicle, in particular motor vehicle or rail vehicle, in which the vehicle obstacle detection is operated in such a way that it predicts obstacles on the basis of at least one first AI/ML model operated on the vehicle and one second AI/ML model, and based on a first prediction and a second prediction.

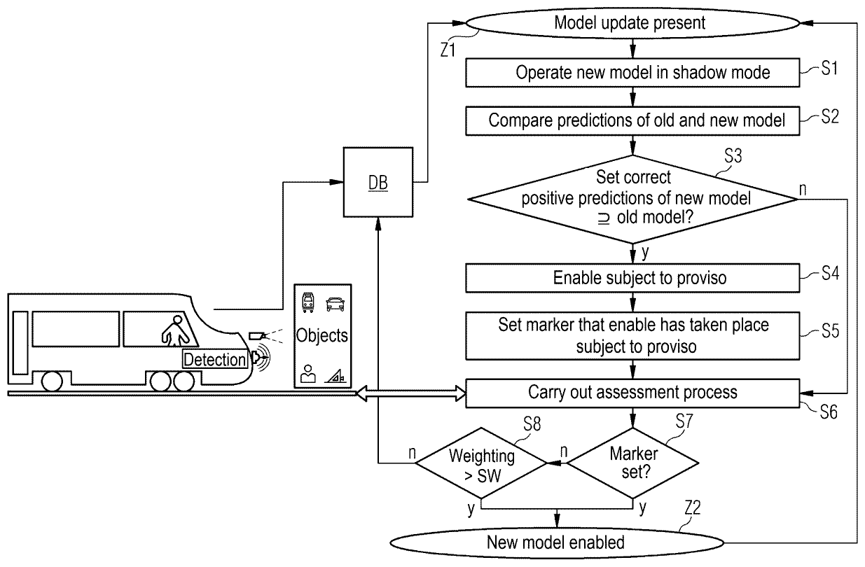

### CROSS-REFERENCE TO RELATED APPLICATIONS

This application claims priority to DE Application No. 10 2025 109 694.5 filed Mar. 13, 2025, the contents of which are hereby incorporated by reference in their entirety.

### TECHNICAL FIELD OF THE INVENTION

This disclosure relates to a device, system and method for operating AI/ML-based obstacle detection for a vehicle, in particular motor vehicle or rail vehicle.

The invention relates to a device, system and method for operating AI/ML-based obstacle detection for a vehicle, in particular a motor vehicle or rail vehicle, and to an arrangement for operating AI/ML-based obstacle detection for a vehicle, in particular motor vehicle or rail vehicle.

### BACKGROUND

It is known that systems realized fully or partially by components based on artificial intelligence (AI), or on machine learning (ML), are updated more frequently than conventional systems.

This is generally due to the fact that such components are generally trained further, not least including based on feedback provided during use, which leads to the improvement of the AI/ML components. This is particularly advantageous in safety-relevant systems. In such areas of application, it is desirable for the improvements to be implemented quickly.

However, in examples in which the AI/ML components perform safety-relevant functions, for example obstacle detection in a train, in particular a driverless train, complex verification and validation may be necessary before an AI/ML model is deployed.

The models used in AI/ML may therefore be not only trained, but also verified, tested and validated before deployment. Verification/testing and validation may be carried out in a test environment. In addition, an approval process may be run through, and a new version of an AI/ML model may be deployed after a successful assessment. This may consume a great deal of time and contradicts the objective whereby improvements should be rolled out quickly.

The object on which the invention is based is that of providing a solution that overcomes at least one of the following disadvantages: excessive delays and accuracy in model output and update. In particular, the object of the invention is to provide a technical solution that enables a method for operating AI/ML-based obstacle detection in a vehicle, in particular motor vehicle or rail vehicle, with a time-saving and accurate update.

### SUMMARY

In one of various examples, the method and arrangement for operating AI/ML-based obstacle detection for a vehicle, in particular motor vehicle or rail vehicle, may proceed from the arrangement for operating AI/ML-based obstacle detection for a rail vehicle.

In one of various examples, the method for operating AI/ML-based obstacle detection for a vehicle, in particular motor vehicle or rail vehicle, in which the vehicle obstacle detection is operated in such a way that it predicts obstacles on the basis of at least one first output signal based on at least one first AI/ML model operated on the vehicle and is taken into account for the operation of the vehicle, wherein the first AI/ML model, on the basis of at least one input signal, generates the first output signal, which forms the basis for the first prediction. The method further includes steps of:
a) at least one second AI/ML model may be installed and operated on the vehicle, in parallel with the first AI/ML model, in such a way that the input signal may be supplied thereto and it generates at least one second output signal based on the second AI/ML model, which may be the basis for a second prediction, which may be processed by the obstacle detection in such a way that it is ignored for the operation of the vehicle,
b) at least a portion of the first prediction is compared with at least a portion of the second prediction, at least until a stop condition is reached,
c) at least one of the first and second prediction may be recorded in such a way that at least one enable criterion may be ascertained,
d) when the stop condition is present, the enable criterion is verified in such a way that, in the event that the enable criterion is satisfied, the second prediction may be at least temporarily taken into account for the operation of the rail vehicle and the first prediction may be at least temporarily ignored for the operation of the vehicle. In one of various examples, the method makes it possible to operate a new model in a shadow mode on the vehicle and to test said model at least until the stop condition is present, without having to deal with negative consequences of implementing the new model. The stop condition may involve one or more variables that ensure sufficient testing. The specific values involved may be determined by optimization calculations, the use of simulation, the use of a digital twin or in a “trial and error” process, or via another process not specifically mentioned. The stop condition may thus for example be that of reaching a certain operating duration and/or a certain route coverage, in particular a duration or route coverage for which it may be assumed that there are sufficient predictions of obstacles or missing predictions of the first model, these being recorded such that, when the stop condition is reached, an enable criterion is able to be given based on the first and second predictions. This means that, for an enable, an assessment is carried out on the basis of at least the first predictions and the second predictions. The criterion may be determined here, in a manner comparable to the stop condition, using optimization calculations, simulation, a digital twin or other methods in such a way that the attainment of at least one property classified for example as high-priority, given in particular by prioritized safety considerations, performance and/or resource utilization, is checked and, if this is the case, the new model is activated on the rail vehicle, that is to say the obstacle detection is then based on the new model. The fact that this is carried out at least temporarily means that provision may also be made, in particular depending on the underlying enable criterion, for further tests and/or classifications to take place following the activation, these helping to test the reliability of the new model more extensively. This makes it possible to find new comparison values for future model updates and/or training data. However, this approach also allows in principle for more flexible developments, for example enabling a rollback to the previous model should serious errors become apparent after the enable. The arrangement for operating AI/ML-based obstacle detection for a rail vehicle according to the method as claimed in one of the preceding claims is characterized by means for carrying out the method.

One of various examples realize the implementation of the method in structural terms and thus contribute to achieving the advantages of the method.

Further advantageous configurations and developments of the invention may be specified by the dependent claims.

Unless stated otherwise in the description of the invention and its developments, the terms “carry out”, “implement”, “transform”, “transmit”, “calculate”, “computer-aided”, “compute”, “determine”, “generate”, “configure”, “reconstruct”, “ascertain”, “record” and the like preferably relate to operations and/or processes and/or processing steps that change and/or generate data and/or convert data into other data, wherein the data may be represented or be present in particular in the form of physical variables, for example in the form of electrical pulses. The expression “computer” should in particular be interpreted as broadly as possible in order in particular to cover all electronic devices having data processing properties. Computers may thus be for example personal computers, servers, programmable logic controllers (PLC), hand-held computer systems, pocket PC devices, mobile radio devices and other communication devices that are able to process data in a computer-aided manner, processors and other electronic data processing devices.

In connection with the invention, “computer-aided” may be understood to mean for example an implementation of the method in which in particular a processor performs at least one method step of the method.

In connection with the invention, a processor may be understood to mean for example a machine or an electronic circuit. In particular, a processor may be a main processor (central processing unit, CPU), a microprocessor or a microcontroller. A processor may also for example be an IC (integrated circuit), in particular an FPGA (field-programmable gate array) or an ASIC (application-specific integrated circuit), or a DSP (digital signal processor) or a graphics processor GPU (graphics processing unit). A processor may also be understood to mean a virtualized processor, a virtual machine or a soft CPU. It may also be for example a programmable processor that is equipped with configuration steps for performing said method or is configured with configuration steps such that the programmable processor implements the inventive features of the method.

A “memory unit”, “memory device” or “memory module” may be understood to mean, without limitation, a volatile memory in the form of random access memory (RAM) or a persistent memory such as a hard disk or a data medium, and also a combination of one or more of these elements so as to form a cloud storage element.

A “module” may be understood to mean for example at least one processor and at least one storage unit for storing program instructions that are connected in a functionally interacting manner physically at one location, for example part of a printed circuit board. By way of example, the processor may be configured to execute the program instructions such that the processor performs functions for implementing or realizing the method.

In one of various examples of the method, in order to ascertain the enable criterion, the presence and/or properties of predicted obstacles of the second AI model and the presence and/or properties of predicted obstacles of the first AI model are verified and a quantitative and/or qualitative first classification may be carried out and stored in a structured manner.

This, as one of various examples, establishes a basis for the enable, which comprises ascertaining the positive predictions of the first, or old, model and the second, or new, model and whether they are correct. It may be also possible to determine, for each obstacle that the new model predicts, whether this obstacle was also predicted by the old model, and so a direct comparison may be possible. It is thus conceivable to classify whether the predictions of obstacles were correct, and which ones these were. By virtue of the storage, this may also be retrieved at later times, wherein the structuring provides an assignment that facilitates the evaluation, and in one of various examples may make such assignment faster. By way of example, it is thereby made possible to check whether the new model predicts at least the same obstacles as the old model, and thus whether the set of obstacles predicted by the new model thus comprises the set of obstacles predicted by the old model, that is to say whether it represents a superset.

These results may be used for example in the development of the method in which the first classification may be carried out in such a way that at least first predictions and/or second predictions may be ascertained, these having predicted an obstacle, and the verification is carried out in such a way that discrimination is carried out as to whether or not the respective prediction was correct and/or whether or not a respective missing prediction was correct. This development may ascertain not only the correct prediction of obstacles, but also the correct failure to predict obstacles, which may also be regarded and/or embodied as negative predictions. This makes it possible to implement classification of false positive/negative predictions and true positive/negative predictions.

As one of various examples, the enable criterion may be set as satisfied if the classification reveals that at least the set formed by correct second predictions is the same as the set formed by correct first predictions. This indicates that an enable may be given when at least the same set of obstacles is detected by the new model and by the old model. Model updates may generally not only improve the predictions, but also bring about further improvements, such as better stability, resource utilization, performance or other improvements to system parameters. Together with the fact that at least the same obstacles are detected, there is therefore overall a minimum requirement in terms of safety and an improvement in terms of the system, and so it makes sense to activate the model if at least the sets of positive predictions match—or, according to the following development, the set formed by correct positive predictions of the new model even goes beyond this, that is to say forms the superset. As one of various examples, temporary enabling, in which further testing is carried out may be advantageous, for example, in order to assess whether the detected obstacles bring the same safety bonus as the old model.

As one of various examples, the method may be developed in such a way that the enable criterion is set as satisfied if the first classification reveals that at least the set formed by correct second predictions is larger than or the same as the set formed by correct first predictions, such that the set of obstacles correctly detected by the new model is thus a superset to the set of obstacles correctly detected by the old model, or the obstacles correctly detected by the old model is a subset of the obstacles correctly detected by the old model.

As one of various examples, the method may also be developed in such a way that the enable criterion may be considered to be satisfied if the classification reveals that the set formed by correctly missing second predictions forms a superset in comparison to the set formed by correctly missing first predictions. This also takes into account the negative predictions, that is to say whether it was correct that there was no obstacle. Although incorrect predictions are less of a concern from a safety point of view, as they are then only operated as an extra precaution, as it were, they may lead to distractions for the train driver and may interfere with operation, and so this development makes it possible to improve the quality and/or safety of an enabled model.

As one of various examples, the method may be developed in such a way that a second classification is carried out for first predictions and/or missing first predictions that differ from the second predictions and/or missing second predictions, positive predictions or negative predictions (missing predictions) that differ from the old model may be supplied to an assessment that may for example lead to an enable, even if the positive and/or negative second predictions are lower in terms of quantity.

As one of various examples, the method may be developed in such a way that a classification process for carrying out the second classification for the second prediction is carried out in such a way that it is carried out on the basis of events recorded during operating phases of the vehicle and correlating with operation. Operating parameters are thereby used directly for classification, meaning that it is possible to determine, for missing predictions that did not exist in the old model, based on the operating parameters, whether these missing predictions are of high quality, but at least correct.

As one of various examples, the classification process for the second prediction may be carried out in such a way that it is carried out after operating phases of the vehicle, this being carried out on the basis of at least portions of structurally stored events recorded during the operating phases, in particular at discrete times, and correlating with operation, it is possible to ensure that ongoing operation is disturbed as little as possible by the classification procedure.

As one of various examples, the method may advantageously be developed in such a way that the classification is carried out based on a third AI obstacle detection model that is trained in particular on a correlation with events occurring during operation. Automation is thereby achieved, which also makes classification faster.

As one of various examples, the method may be developed in such a way that, for the classification process, the second classification is carried out by recording driver feedback. As a result, either the third AI model may be supported and/or a solution independent of a model is provided.

As one of various examples, events correlating with operation may be recorded in such a way that, when approaching a location of an obstacle as predicted according to the second prediction or an actual obstacle, at least one operating parameter recorded in particular on the basis of first sensors is evaluated, such as for example initiation of braking, speed parameters, such as for example deceleration, acceleration or staying at constant speed, and/or environmental parameters recorded by second sensors, such as lidar, radar and similar environmental monitoring devices, are evaluated. This achieves recording of events, which enables accurate assessments.

As one of various examples, the method may include a respective timestamp assigned for at least a portion of the first predictions and at least a portion of the second predictions, and the portion of the first predictions and the portion of the second predictions may be stored with the respective timestamp in a structured manner in such a way that first and second predictions of the same timestamp are stored in a manner able to be read for comparison. This makes it possible for example to recognize whether first and second (missing) predictions match, as an assignment over time becomes possible.

As one of various examples, the method may be developed in such a way that the first portion and the second portion are stored in a structured manner in such a way that, in a manner assigned to the respective timestamp, the operating parameters, which are in particular recorded by the first sensors, and the environment parameters, which are in particular recorded by the second sensors, are stored in a manner able to be read together with the first prediction and/or second prediction.

As one of various examples, the method may be developed in such a way that the second classification is carried out in such a way that the comparison of the first prediction and the second prediction is submitted to the train driver and/or the third AI model at a time, in particular shortly after the recording of an event correlating with operation and/or after the operating phase by reading the structured storage, the feedback from the vehicle driver and/or the third AI model is stored in a structured manner as a classification associated with this comparison.

### BRIEF DESCRIPTION OF THE FIGURES

Further advantages and details of the invention as well as developments of the invention are explained in more detail below using an exemplary embodiment shown in the single FIGURE, in which the

The single FIGURE illustrates one of various examples of the method.

### DETAILED DESCRIPTION

The exemplary embodiment explained below in the FIGURE is one of various embodiments, on the basis of which advantages and further embodiments or developments of the invention are explained in more detail.

In particular, the explanations that follow merely show exemplary implementation possibilities, and how in particular such implementations of the teaching according to the invention could be manifested.

In the exemplary embodiments, the described components of the embodiments each represent individual features of the invention that should be considered independently of one another, and that each also develop the invention independently of one another and should therefore also be considered to be a constituent part of the invention individually or in a combination other than that shown.

Furthermore, the described embodiments may also be supplemented by further features of the invention that have already been described.

In the FIGURE, the implementation of the method according to the invention is illustrated schematically, with reference to a flowchart in connection with a rail vehicle. It is possible to see a rail vehicle, including but not limited to a train, which comprises a target platform with obstacle detection based on a component that operates one or more AI/ML models for predicting possible detected obstacles, a selection of which is illustrated schematically.

It is also possible to see a schematic sequence of the method, which acts on the train, in particular is carried out in a computer-aided manner, in particular is at least partially computer-implemented, and interacts at least partially with sensors and components generating input or output signals in order to enable the updating of the component implemented for the obstacle detection; in the present example, this is an AI/ML model KI/ML1

For this purpose, proceeding from a first state Z1 “model update”, in a first step S1, a new version of the AI/ML model KI/ML2 may be deployed and operated in parallel with the old AI/ML component KI/ML1 in such a way that the new AI/ML model KI/ML2 is deployed on the target platform without replacing the existing component, that is to say the old model KI/ML1, and that in the process the input signals and pulses that would normally be sent to the old component KI/ML1 are also forwarded to the new component, that is to say the new model KI/ML2, wherein the output signals of this new component KI/ML2 are not forwarded to the target platform until a trigger event occurs. This parallel operation is also referred to as “shadow mode” within the scope of this disclosure.

The second AI/ML model KI/ML2 may thus be tested in this shadow mode. As one of various examples, the model may be subjected to a test procedure even before the parallel deployment. This may be advantageous in order to ensure that the new model KI/ML2 is already operating correctly on the target platform, that is to say to determine the basic functionality of the implementation, so that the parallel run may essentially focus on the quality of the prediction.

As one of various examples, predictions may however also be subjected to a test in advance. By way of example, in order to subject edge/corner cases to a test in this test phase, which is more likely to be associated with the development phase, before the parallel implementation in shadow mode takes place.

This may speed up the activation of the new model KI/ML2 or prevent the new model KI/ML2 from being able to be activated at all due to the occurrence of edge and corner case problems.

The first step S1 is followed by a second step S2, in which the first output signals, the prediction based thereon and/or the detection resulting therefrom are compared with the second output signals, the prediction based thereon and/or the prediction resulting therefrom.

According to one of various examples, this may be carried out for a certain period of time. As one development, the length of this time may be able to be set. As one of various examples, this time may also be predefined. One advantageous development is for this to be a time interval in which it is possible to ensure, with a sufficiently high probability, that all kinds of possible predictions of the first model KI/ML1 have occurred, that is to say in particular all kinds of obstacles have been predicted and/or actually existed.

As one of various examples, the period of time may be stopped when this condition is reached and/or the period of time may be until other stop conditions, for example detection of an in particular manually generated stop signal, are reached.

In a third step S3, which runs after the period of time and/or already runs in parallel with the second step S2, a check may be carried out as to whether the predictions of the two models KI/ML1 . . . 2 have at least the same “true positives”, that is to say correct prediction of obstacles in the period of time; in other words, the set of true positives that the first model KI/ML1 predicts is a subset of the set of true positives that the second model KI/ML2 predicts. Relationships between sets such as these are described below, in part for ease of simplification, using the wording “number of predictions” in conjunction with “larger”, “smaller” and/or “”, meaning that, if this wording is used in connection with a comparison of the predictions of the new model KI/ML1 with the predictions of the old model KI/ML2, it describes how the number of matching predictions behaves.

Thus, if the check reveals that the set true positives of the second model KI/ML2 comprises at least all true positives of the first model KI/ML1, then, according to one of various embodiments, the second model KI/ML2 is activated and then is in a second state Z2 “model enabled”. The update containing the second model KI/ML2 also generally entails an improvement in terms of performance at execution, in particular runtimes, resource utilization, code optimizations and/or other performance-influencing parameters and, together with the test result, this thus ensures that at least the hit rate for correctly detected obstacles of the old model KI/ML1 is maintained, while at the same time achieving a performance improvement. Activation depending on this result might thus avoid a time-consuming enable procedure and still improve obstacle detection.

According to one of various examples, this activation may also be carried out under the stated condition if the set of incorrect positive predictions, that is to say predicted obstacles that are not, is larger in the new model KI/ML2 than in the old model KI/ML1, if the obstacle detection is operated in such a way that the highest priority of safety is to be ensured and thus incorrect positive predictions are accepted. In such a case, if the new model KI/ML2 with its correct predictions forms a superset in relation to the correct predictions of the first model KI/ML1, activation would take place, in particular regardless of performance, and with the same number of matching correct predictions, the performance improvement would lead the activation to a positive activation decision in spite of incorrect positive predictions.

The probability of such activation is increased by the above-described testing of performance and edge and corner cases in advance, according to one development.

According to one of various examples, the method may then operate the obstacle detection in such a way that, in a fourth step S4, the new model KI/ML2 is activated subject to proviso and its predictions are used for obstacle detection, while the first model KI/ML1 may be decommissioned and the resources occupied thereby may be released.

It is conceivable for this release, according to one of various examples, to be deferred for an in particular definable time and/or until an in particular manual trigger event occurs, in order to have a fallback position if problems arise when operating the new model following the activation in the fourth step S4.

If the comparison in the third step S3 reveals that fewer correctly detected objects are predicted by the new model KI/ML2 than by the old model KI/ML1, provision may be made, for an assessment process to be carried out, in which the set of incorrect negative predictions, that is to say a failure to detect obstacles actually present, by the new model KI/ML2 with the set of these incorrect negative predictions of the old model KI/ML1, the set of correct negative predictions of the two models KI/ML1 . . . 2, the set of incorrect positive predictions of the two models KI/ML1 . . . 2 and/or the number of correct positive predictions are also recorded individually or in combination with one or more of said predictions and the individual predictions of the respective set are stored in a structured manner, such that, as an alternative or in addition, on the basis of these data, when a decision criterion, in particular a threshold, is reached, the new model KI/ML2 is activated.

These data may also, in one of various examples, be supplied for fine tuning/training on the target platform and/or to a separate further development.

As one of various examples, the assessment process or the decision criterion may take into account the following weighting/assessment of the predictions. As one of various examples, these weightings may in particular be represented by corresponding values, thus enabling automation of the assessment by comparison with threshold values;

As one of various examples, the following results over time of a comparison of the predictions of both models KI/ML1 . . . 2 may be reached:
a) The result of a new and old model is functionally identical
b) New model KI/ML2 finds more objects than the old model KI/ML1, then the following ratings may be given
   In the event of incorrect positive predictions, that is to say additional, non-existent objects are mistakenly detected, which the old model KI/ML1 does not mistakenly detect, this leads to the partial rating deterioration
   In the event of correct positive predictions existing objects are detected, which the old model KI/ML1 does not detect, this leads to the partial rating improvement
c) New model KI/ML2 finds fewer objects than the old model KI/ML1, then the following ratings may be given:
   In the event of incorrect negative predictions, that is to say existing objects are mistakenly not detected, which the old model correctly detects, this leads to the partial rating deterioration
   In the event of correct negative predictions, that is to say non-existent objects are correctly not detected, which the old model mistakenly detects, this leads to the partial rating improvement

These ratings may also be supplied for example as labels for an improvement of the new model KI/ML2 during operation and/or to a development environment operated separately from the target platform. As one of various examples, these ratings may be assigned values according to predetermined weightings, such that the evaluation of the predictions by way of a function over these values may lead to a total value that may lead or at least contribute, for example by way of threshold value comparison, to an automatic decision concerning activation. As one of various examples, a display of the final rating and/or the intermediate ratings on a display device is also conceivable.

The weighting in the context of the rating may, as one of various examples, be based on the following relationships, in particular supplied to an AI-based model for weighting, in order to obtain a value for the threshold value decision and/or to make the threshold value decision itself:
a) Deteriorations caused by more incorrect positive predictions lead to unnecessary distraction for the train driver or unnecessary braking, and thus interfere with operation, but are basically acceptable, accompanied by a reduction in availability: Minor safety relevance and thus a correspondingly low negative weighting
b) Deteriorations caused by more incorrect negative predictions may lead to a safety risk, since a possible collision is not automatically detected, and are therefore unacceptable: Safety-relevant and therefore a correspondingly high positive weighting
c) Improvements caused by more correct positive predictions lead to higher safety, since ignoring a higher number of correct positive predictions would essentially represent a higher safety risk, and a new model would not be activated in such a case: It is therefore safety-relevant with a correspondingly high positive weighting
d) Improvements caused by more correct negative predictions lead to fewer unnecessary disruptions during operation and are therefore desirable, as they lead to an improvement in the availability of the rail vehicle: Minor safety relevance and therefore a low positive weighting

As illustrated in the FIGURE, it should be assumed that this assessment is also carried out if the result in the third step S3 has led to activation, such that, while the new model KI/ML2 is already operating for obstacle detection, data and/or assessments are collected and used externally in the course of the assessment process, as an alternative or in addition to the activation assessment in order to improve the new model KI/ML2 in situ and/or after being supplied to a development platform.

As one of various examples, in a fifth step S5, the method may set a marker that the activation has taken place and the assessment procedure does not make an activation decision at the end of its collections, but only collates data/classification collections and stores them in a structured manner.

As may be seen in the FIGURE, the assessment process follows this fifth step S5 or after a negative result in the third step S3.

This leads to an assessment of the predictions in real time and/or afterwards.

For a real-time assessment, according to developments of the method according to the invention, one or more of the following steps may be carried out as part of the sixth step S6:
The train driver is asked by outputs from the obstacle detection system to classify additional positive predictions, that is to say obstacle predictions, that are correct and missing negative predictions, that is to say non-detected obstacles, with labels such as “false” or “true”.
This may be done, as one of various examples, fully automatically or additionally also by an AI-supported classification module, which is supplied with output signals by the operated obstacle detection.
The classification may also be carried out automatically by not asking the train driver for an assessment, but rather through system-side evaluation of the train control system, which indicates “coherent action”. As one of various examples, if an unexpected braking procedure is initiated while the old model does not detect an obstacle, an additional “true” (correct obstacle prediction) label should be assumed, otherwise a “false” (incorrect obstacle prediction). If an expected braking procedure is not initiated even though the old model detects an obstacle, a “true” label (correct prediction that there is no obstacle) of the new model should be assumed. This is advantageous because the train driver is not distracted while driving. As an alternative or in addition, this development may also be embodied in such a way that the train driver and/or the abovementioned AI-based classification system carries out confirmation or correction using these labels at a later time, that is to say for example when the possible collision risk is over. This has the advantage of correcting scenarios that may be misinterpreted. By way of example, it may be the case that objects close to the track were correctly detected but did not require braking.
As one of various examples, the assessment process may be developed in such a way that a comparison is carried out with further sensor data from sensors that are activated in particular on an event-controlled basis, for example as soon as the train approaches the obstacle. Sensors could for example be devices such as lidar, radar and/or other sensors suitable for detecting the environment.
As an alternative or in addition, there may be an additional component for the assessment over time of the predictions that the respective models KI/ML1 . . . 2 make. If there is a difference between the outputs of the old and new model in a time interval I1 followed by a time interval I2 in which the outputs match, it is obvious that one of the model versions has already detected the (supposed or actual) object earlier (correctly or mistakenly). This advantageously makes it possible to deal with the following exemplary situations, without limitation: It is assumed that the outputs from the model versions differ at a time t1, at which the train is for example 500 m away from an assumed obstacle, but agree at a later time t2, at which the train is only 300 m away, and if this also remains the same from this time onward, then one of the versions has detected the obstacle earlier. Or assume that one of the models has hallucinated and incorrectly detected an obstacle when the distance was even greater, but both agree later that there was no obstacle, then this is also dealt with by this development, such that, if the new model, which is the one that detected an obstacle earlier, or that did not mistakenly detect an obstacle, is identified as the one that is better than the old one.

For a subsequent assessment, as one of various examples of the real-time assessment, one or more of the following steps may be carried out as part of the sixth step S6:
recordings of camera streams, train-mounted cameras and/or other sensors, and the different object lists of the two models, are provided at a later time as a request for analysis for the train driver and/or the AI-based classification. In order to conserve resources such as memory, these recordings may, as an alternative or in addition, at least be limited to time intervals in which the object lists deviate.

Following completion of the assessment process in the sixth step S6, as one of various examples, a check may be carried out in a seventh step S7 to determine whether or not the marker was set in the fifth step S5. This means whether the activation has already taken place and the assessment procedure is used to train and improve the new model KI/ML2, or whether the assessment procedure has been ascertained as the basis for activation.

If this check reveals that the marker was set, then the assessment data are made available to train the new model KI/ML2 on the train, or this training is carried out and/or the data are supplied to the development platform so that they are able to be used as a basis for future updates of the model. This is illustrated in schematically simplified form by the arrow from the train to an external database DB.

If the marker is not set, a query is made in an eighth step S8 as to whether the quality weighting GW has exceeded the activation threshold value SW.

In addition to the weighting principles already mentioned above, as one of various examples, the quality weighting of the new model KI/ML2 may be determined as follows:
a) If there are additional correct obstacle predictions, but no additional incorrect predictions of non-existent obstacles, the new model KI/ML2 is safer and should be activated. However, if there are so many additional incorrect obstacle predictions that it may be the case that the train driver could be distracted too often, or ignores the driving assistance system, a weighting is given to the effect that the model cannot be used in practice, which goes against rollout or activation.
b) If there are additional incorrect predictions of non-existent obstacles compared to the old model KI/ML1, the new model KI/ML2 must be rejected unless the additional correct predictions of obstacles are greater in number than those of the old model KI/ML1.
c) As one of various examples, an AI-based or human audit initiated by a request from the system may be used to refine the weighting, taking into account whether the incorrect unpredicted obstacles related to non-critical objects, while the correct positive predictions referred to more critical objects, which suggests a weighting that allows activation/rollout.

If there are no safety-relevant improvements due to correct positive predictions and no safety-relevant deteriorations due to incorrect unpredicted obstacles, then a weighting may be given for rollout/activation as to whether the new model KI/ML2 leads to fewer operational problems overall, that is to say whether there are more correct unpredicted obstacles than there are incorrect positive obstacle predictions compared to the old model KI/ML1.

If the weighting results in activation, a decision is made, in the eighth step S8, that activation should take place, and this is then also carried out on the train.

If the threshold value SW is not exceeded, this means that the rollout of the new model KI/ML2 should be rejected and needs to be improved, for example on the basis of the data collected during the assessment process. This is illustrated in simplified form by the arrow to the database DB.

If an improved model is available, this may be installed on the train again starting with the first state Z1 in the manner according to the invention and steps S1 to S8 may be repeated. This is symbolized firstly by the arrow from the database DB to the first state Z1 and secondly by the arrow from the second state Z2 to the first state Z1, as this will generally take place starting from an enabled model.

The method according to one of various examples, may achieve, among other advantages:
Accelerated deployment
Shorter time to put new AI/ML models into service
New model is continuously tested
Test is carried out on the hardware under realistic conditions (cf. acceptance test)
Approval by proven-in-use argument possible

The method may help to detect critical/severe scenarios in the field in which models often deviate, and thus to obtain training and test data.

The invention is not restricted to the described exemplary embodiments and developments. On the contrary, the invention comprises all combinations defined by the claims and limited by their scope of protection.

It is also conceivable, for example, for the abovementioned post-training to take place on the train for certain scenarios identified in the field or in combination with other models, for example as an ensemble.

Irrespective of the grammatical gender of any particular term, persons identifying as male, female or any other gender are included.

1. A method for operating AI/ML-based obstacle detection for a vehicle, in particular motor vehicle or rail vehicle, in which the vehicle obstacle detection is operated in such a way that it predicts obstacles on the basis of at least one first output signal based on at least one first AI/ML model operated on the vehicle and is taken into account for the operation of the vehicle, wherein the first AI/ML model, on the basis of at least one input signal, generates the first output signal, which forms the basis for the first prediction, characterized in that
a) at least one second AI/ML model is installed and operated on the vehicle, in parallel with the first AI/ML model, in such a way that the input signal is supplied thereto and it generates at least one second output signal based on the second AI/ML model, which is the basis for a second prediction, which is processed by the obstacle detection in such a way that it is ignored for the operation of the vehicle,
b) at least a portion of the first predictions are compared with at least a portion of the second predictions, at least until a stop condition is reached,
c) the first and/or second prediction are/is recorded in such a way that at least one enable criterion is able to be ascertained, and
d) when the stop condition is present, the enable criterion is checked in such a way that, in the event that the enable criterion is satisfied, the second prediction is at least temporarily taken into account for the operation of the vehicle and the first prediction is at least temporarily ignored for the operation of the vehicle.

2. The method as claimed in claim 1, where in the presence and/or properties of predicted obstacles of the second AI model and the presence and/or properties of predicted obstacles of the first AI model are verified and a quantitative and/or qualitative first classification is carried out and stored in a structured manner.

3. The method as claimed in claim 2, wherein the first classification is carried out in such a way that at least first predictions and/or second predictions are ascertained, these having predicted an obstacle, and the verification is carried out in such a way that discrimination is carried out as to whether or not the prediction was correct and/or whether or not a missing prediction was correct.

4. The method as claimed in claim 3, characterized in that the enable criterion is set as satisfied if the classification reveals that at least the number of correct second predictions is equal to the number of correct first predictions, wherein, for each correct first prediction of the obstacle, the correct second prediction for the same obstacle exists.

5. The method as claimed in claim 4, wherein the enable criterion is set as satisfied if the classification reveals that at least the set of correct second predictions is larger than or the same as the set of correct first predictions, and the set of correct second predictions is a superset of the set of correct first predictions.

6. The method as claimed in claim 5, wherein the enable criterion is considered to be satisfied if the classification reveals that the number of missing second predictions is greater than or equal to the number of missing first predictions.

7. The method as claimed in claim 6, wherein a second classification is carried out for first predictions and/or missing first predictions that differ from the second predictions and/or missing second predictions.

8. The method as claimed in claim 7, wherein a classification process for carrying out the second classification for the second prediction is carried out in such a way that it is carried out on the basis of events recorded during operating phases of the rail vehicle and correlating with operation.

9. The method as claimed in claim 8, wherein the classification process for the second prediction is carried out in such a way that it is carried out after operating phases of the vehicle, this being carried out on the basis of at least parts of structurally stored events recorded during the operating phases, in particular at discrete times, and correlating with operation.

10. The method as claimed in claim 9, wherein the classification is carried out based on a third AI obstacle detection model that is trained in particular on a correlation with events occurring during operation.

11. The method as claimed in claim 10, wherein, for the classification process, the second classification is carried out by recording train driver feedback.

12. The method as claimed in claim 2, wherein events correlating with operation are recorded in such a way that, when approaching a location of an obstacle as predicted according to the second prediction or an actual obstacle, at least one operating parameter recorded in particular on the basis of first sensors is evaluated, such as for example initiation of braking, speed parameters, such as for example deceleration, acceleration or staying at constant speed, and/or environmental parameters recorded by second sensors, such as lidar, radar and similar environmental monitoring devices, are evaluated.

13. The method as claimed in claim 12, wherein a respective timestamp is assigned for at least a portion of the first predictions and at least a portion of the second predictions, and the portion of the first predictions and the portion of the second predictions are stored with the respective timestamp in a structured manner in such a way that the first and second predictions of the same timestamp are stored in a manner able to be read for comparison.

14. The method as claimed in claim 13, wherein the first portion and the second portion are stored in a structured manner in such a way that, in a manner assigned to the respective timestamp, the operating parameters, which are in particular recorded by the first sensors, and the environment parameters, which are in particular recorded by the second sensors, are stored in a manner able to be read together with the first prediction and/or second prediction.

15. The method as claimed in claim 4, wherein the second classification is carried out in such a way that the comparison of the first prediction and the second prediction is submitted to the vehicle driver and/or the third AI model at a time, in particular shortly after the recording of an event correlating with operation and/or after the operating phase by reading the structured storage, the feedback from the vehicle driver and/or the third AI model is stored in a structured manner as a classification associated with this comparison.
